(19) United States
(12) Patent Application Publication
(10) Pub. No.: US 2003/0050886 A1
(43) Pub. Date: Mar. 13, 2003

(54) Method and apparatus for managing the versioning of business objects using a state machine

(75) Inventors: Mitchell Adam Cohen, Yorktown Heights, NY (US); John Scott Houston, Hopewell Junction, NY (US); Jianren Li, Valhalla, NY (US); John Joseph Rofrano, Mahopac, NY (US); Josef Schiefer, White Plains, NY (US)

Correspondence Address: Ryan, Mason & Lewis, LLP, 1300 Post Road, Suite 205, Fairfield, CT, 06430, US

(73) Assignee: International Business Machines Corporation, Armonk, NY

(21) Appl. No.: 09/951,027

(22) Filed: Sep. 11, 2001

(51) Int. Cl. G06F 17/60

(52) U.S. Cl. 705/37

(57) ABSTRACT

A method and apparatus are disclosed for managing the versioning of business objects, such as contracts, advertisements, auction listings and RFQs. A state machine is used to represent a business process and manages the versioning of business objects associated with the business process. The present invention manages the original business object, the new version of the object, and any business objects that depend on the modified business object, if necessary. The business object remains in an active state during the modification process, until the new version of the business object is available. The new version of the business object remains in an inactive state during the modification process. The new version of the business object is transferred to an active state and the original business object is transferred to an inactive state when the modification is complete (e.g., when the modified business object is approved). If there are parent-child dependencies, the version management technique of the present invention updates a child object that is dependent on the modified business object, as appropriate.

### CROSS REFERENCE TO RELATED APPLICATIONS

The present invention is related to United States Patent Application entitled “Method and Apparatus for Automatic Transitioning Between States in a State Machine That Manages a Business Process,” (Attorney Docket Number SOM920010005US1), United States Patent Application entitled “Method and Apparatus for Creating and Managing Complex Business Processes,” (Attorney Docket Number SOM920010007US1), United States Patent Application entitled “Method and Apparatus for Monitoring Execution of a Business Process Managed Using a State Machine,” (Attorney Docket Number SOM920010008US1), United States Patent Application entitled “Method and Apparatus for Managing and Displaying User Authorizations for a Business Process Managed Using a State Machine,” (Attorney Docket Number SOM920010009US1) and United States Patent Application entitled “Method and Apparatus for Managing a User Group List For a Business Process Managed Using a State Machine,” (Attorney Docket Number SOM9200100010US1), filed contemporaneously herewith, assigned to the assignee of the present invention and incorporated by reference herein.

### FIELD OF THE INVENTION

The present invention relates generally to techniques for representing business processes as state machines, and more particularly, to a method and apparatus for managing the versioning of business objects.

### BACKGROUND OF THE INVENTION

Business processes, such as those used to manage auctions, contracts, and requests for quotes (RFQs), often require the posting of business objects, such as contracts, advertisements, auction listings and RFQs, for review by many people. Of course, it is often necessary to revise or alter such business objects after they have been posted. In many cases, it would be preferable if these changes could be made without making the object inaccessible or unusable. Currently, however, a user must cancel the original business object and create a new object with the modified parameters. There is also no convenient mechanism for automatically notifying anyone that may be impacted by the contemplated changes.

When the modifications to the object must be approved, or involve other potentially time-consuming actions, the need for constant accessibility becomes even more critical. After all, while a new version of the object is being developed, the current version of the object remains active and valid. While it is important to create and approve the modifications in a speedy and efficient manner, the primary concern is to have the transition be both smooth and complete.

Automatic version control is fairly commonplace for the management of objects, such as documents. Version control is similarly needed for business objects, such as RFQs and contracts. However, versioning such business objects may be more complex, especially when these business objects may have parent-child relationships with other business objects. A need therefore exists for a method and apparatus for managing the versioning of business objects, such as RFQs and contracts, that maintain constant accessibility of the business object throughout the modification process. Yet another need exists for a method and apparatus for managing the versioning of business objects that updates any child objects in an appropriate manner.

### SUMMARY OF THE INVENTION

Generally, a method and apparatus are disclosed for managing the versioning of business objects, such as contracts, advertisements, auction listings and RFQs. The present invention uses a state machine to represent a business process and manages the versioning of business objects associated with the business process. The present invention manages both the original business object and the new version of the object, and also updates any business objects that depend on the modified business object, if necessary.

According to one aspect of the invention, the business object remains in an active state during the modification process, until the revised business object is available. The new version of the business object can be created using one or more attributes of the original business object, one or more modified attributes and, optionally, a reference to the original business object. The new version of the business object remains in an inactive state during the modification process. The new version of the business object is transferred to an active state and the original business object is transferred to an inactive state when the modification is complete (e.g., when the modified business object is approved).

In addition, if there are parent-child dependencies, the version management technique of the present invention updates a child object that is dependent on the modified business object. The dependent business object is updated in accordance with a business process associated with the dependent object. For example, dependent business objects, such as responses to the business object, can be updated to refer to the new version of the business object. In addition, a notification about the modification can be automatically sent to a submitter of a response to the modified business object.

A more complete understanding of the present invention, as well as further features and advantages of the present invention, will be obtained by reference to the following detailed description and drawings.

### BRIEF DESCRIPTION OF THE DRAWINGS

FIG. 1 illustrates an exemplary conventional state machine having two states for managing a business process;

FIG. 2 illustrates a state machine for managing the versioning of an exemplary approval list in accordance with the present invention;

FIG. 3 illustrates a state machine for managing the versioning of an exemplary RFQ in accordance with the present invention;

FIG. 4 is a sample table from an exemplary RFQ response table incorporating features of the present invention; and

FIG. 5 illustrates an exemplary network environment in which the present invention can operate.

### DETAILED DESCRIPTION OF PREFERRED EMBODIMENTS

The present invention focuses on a state machine-based business process that manages the versioning of business objects. The present invention provides a powerful approach for managing the versioning of business objects. It manages both the original object and the new version of the object in a controlled and structured way. This invention also provides a means for keeping child objects up-to-date. Thus, the present invention applies to the immediate object being versioned, and also deals with objects connected to the original object in a parent-child relationship.

### State Machine Terminology

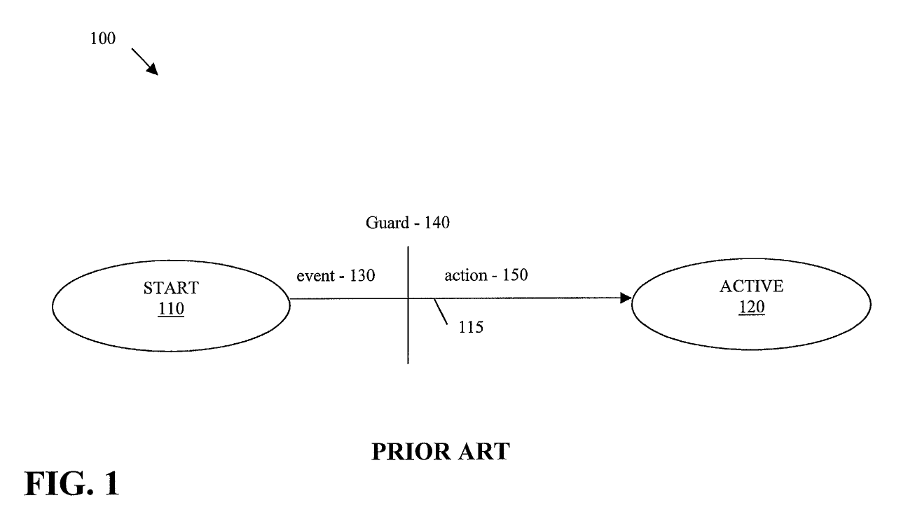

Business processes can be represented using a state machine. State machines provide a way to control the set of events and actions that may be performed throughout the life cycle of a business object. The Unified Modeling Language (UML) provides a standardized syntax for describing state machines. FIG. 1 is an example illustrating a state machine 100 having two states 110, 120 with a single transition 115 leading from the Start state 110 to the Active state 120. The transition 115 is composed of three parts. First, there is an event 130 that defines what may cause this transition 115 to be attempted. Second, one or more guards 140 determine whether or not the transition 115 may be taken based upon some predefined criteria, such as the authority of the user or certain values associated with the business object. Finally, the action 150 provides a means for identifying logic that may act upon, or on behalf of, the object being managed by the state machine 100. Thus, if the transition 115 is allowed according to the guards 140, then the action 150 is performed and the object moves into the Active state 120. The various components of a transition 115 can be expressed using the notation “event [guard] action.”

For a more detailed discussion of techniques for managing business processes using a state machine, see, for example, U.S. patent application Ser. No. 09/818,719, filed Mar. 27, 2001, entitled “E-Market Architecture for Supporting Multiple Roles and Reconfigurable Business Processes,” August-Wilhelm Scheer, Aris—Business Process Modeling, Springer Verlag, 1999 or Peter Muth et al., Enterprise-Wide Workflow Management Based on State and Activity Charts, in A. Dogac, L. Kalinichenko, T. Ozsu, A. Sheth (Editors), Workflow Management Systems and Interoperability, Springer Verlag, 1998, each incorporated by reference herein.

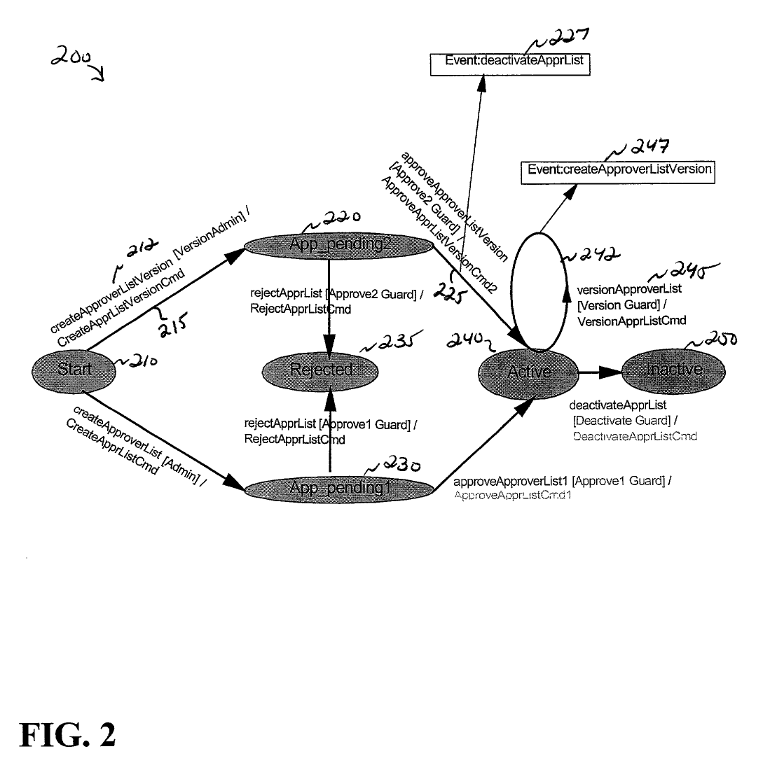

FIG. 2 illustrates a state machine 200 for managing the versioning of an approval list in accordance with the present invention. FIG. 2 illustrates the management of an original object and a new version of the object. An approver list is a list of one or more individuals who are allowed to approve transactions, in a known manner. The approver list may be referenced continuously by other business processes and business objects. Thus, it is critical that it be easily accessible and continuously available.

The state machine 200 contains provisions for managing original objects and versions generated from the original objects, and includes the process for replacing the original object with a new version of the object (once approved). The state machine 200 uses traditional UML notation to describe the transitions: “event[guard]/action.”

A reorganization within a business, for example, may require a change to the list of individuals on the approver list. As shown in FIG. 2, a person with the appropriate authority may invoke the versionApproverList event 245 for the approver list when the list is in an Active state 240. The transition 242 defined with the versionApproverList event 245 for the active state 240 is then selected. The guards of the transition 242 are assessed to determine whether or not the individual who generated the versionApproverList event 245 has the authority to invoke the transition 242. If the individual is found to have the authority by the Version Guard, then a VersionApprListCmd command (the defined “action” associated with the transition 242) is executed and the command generates a createApproverListVersion event 247, as shown in FIG. 2. Once this createApproverListVersion event 247 is generated, the VersionApprListCmd command is complete, and the versionApproverList transition 242 completes with the original object (the original version) returning to the same Active state 240.

Meanwhile, the createApproverListVersion event 247 causes a new object to be created beginning at the Start state 210 of the same state machine 200 that generated the event. The transition 215 associated with the createApproverListVersion event 212 leaving the Start state 210 is selected, and its guards are assessed. If the guards are successfully passed, the CreateApprListVersionCmd copies attributes from the original version of the object, handles any editing of the object, and finally saves it along with a reference to the original object before entering a pending state 220 at the end of the transition (the App_pending2 state 220). In this pending state 220, according to this exemplary state machine 200, the new version of the object waits for a person with Approve2 authority to either approve or reject the changes contained in the new object which is now in the App_pending2 state 220. If an approver rejects the new version of the object, then the object will be moved to the Rejected state 235.

However, if an approver approves the new version of the object, the ApproveApprListVersionCmd2 will be executed. The ApproveApprListVersionCmd2 action must perform several operations to complete the versioning effort and this transition 225 must do more than just move the new version into the Active state 240. One important function to perform is to raise the deactivateApprList event 227 for the original object. This event will be handled by an event handler and will move the old version of the object into the Inactive state 250. The new version of the object will be moved into the Active state 240 to replace the old version. These actions may all be included within the same transaction scope to ensure that the overall action is atomic.

If the object being managed is more complex, such as with a Request For Quote (RFQ) object, there may be additional concerns to address. The object that is being versioned may have multiple business objects (such as RFQ Responses) dependent upon it under a parent-child relationship. Because of the flexibility and power of the method of the present invention, only simple modifications are required to the state machine 200 from the previous Approver List example to address the dependency issues.

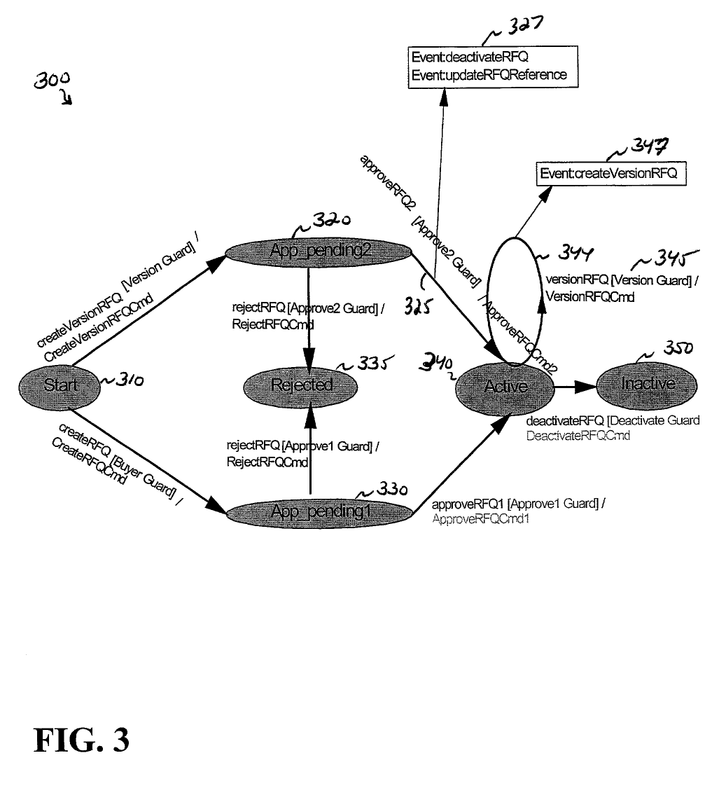

FIG. 3 illustrates a state machine 300 for managing the versioning of an RFQ in accordance with the present invention. This process will manage both the original and new versions of the RFQ, and also cause necessary changes to be made for any dependent objects using their own business process. The information contained in the dependent objects will be updated appropriately with the information from the new RFQ request object. If any state changes are needed for the dependent objects, the next states to move these objects into will depend on the business processes to which those objects belong.

The most significant change to the RFQ state machine 300 shown in FHG. 3 relative to the Approver List state machine 200 shown in FIG. 2 (other than the names of the events, guards and commands) is to the actions performed by the command on the transition from the App_pending2 state 320 to the Active state 340. In addition to managing the current object and generating an event to handle the old version, this command must also deal with any objects that were dependent upon the old version of the object. For example, RFQ responses to the old version of the RFQ object are dependent on the parent RFQ object.

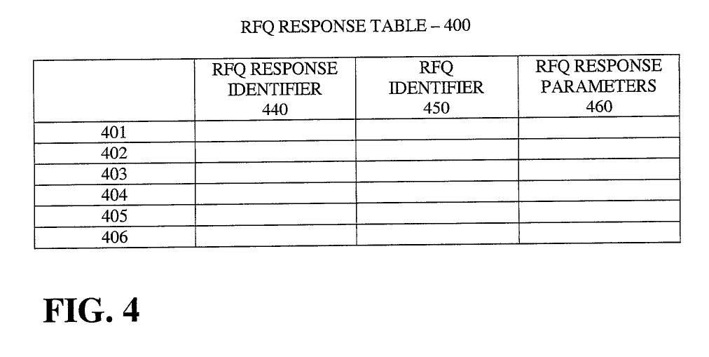

To move the original object to Inactive state 350, the current object is moved to the Active state 340, an identifier is obtained for the original object, e.g., from a FlowInstance table, and a synchronous deactivateRFQ event is raised to move the original object to the inactive state 350. In addition, if there are dependent objects that must be updated, an exemplary RFQ response table 400, discussed below in conjunction with FIG. 4, using the RFQ flow identifier to obtain the list of related RFQ responses. For each RFQ response, an updateRFQReference event is raised.

Although the actual effects upon these child objects may vary depending on the specific business situation, two exemplary actions that may be performed on the child RFQ responses are discussed herein. These actions may include updating references in the RFQ responses to refer to the new version of the RFQ object and sending notifications to these object owners that their original RFQ has changed. If the actions from ApproveRFQCmd2 (associated with transition 325) cause a change in the state of the child objects, then these changes must be handled by their own managing processes. These changes will be triggered by the ApproveRFQCmd2 generating the appropriate event for each child object to cause the appropriate action to be taken in each case. For example, the RFQ responses may be moved into canceled states that are defined in the business processes of each of the response. Each canceled state may have its own conditions and actions depending on the individual RFQ response.

FIG. 4 is a sample table from an exemplary RFQ response table 400 incorporating features of the present invention. As shown in FIG. 4, the RFQ response table 400 includes a plurality of records, such as records 401-406, each associated with a different response to an RFQ. For each RFQ response identified in field 440, the RFQ response table 400 indicates the corresponding RFQ in field 450 and any parameters defined in the response in field 460. In this manner, the RFQ identifier in field 450 is used to determine the dependency information. Thus, if a given RFQ is updated in accordance with the present invention, the RFQ response table 400 can be searched for all RFQ responses that are directed to the affected RFQ. If desired, a notification of the revised RFQ can be sent to the submitter of each corresponding RFQ response.

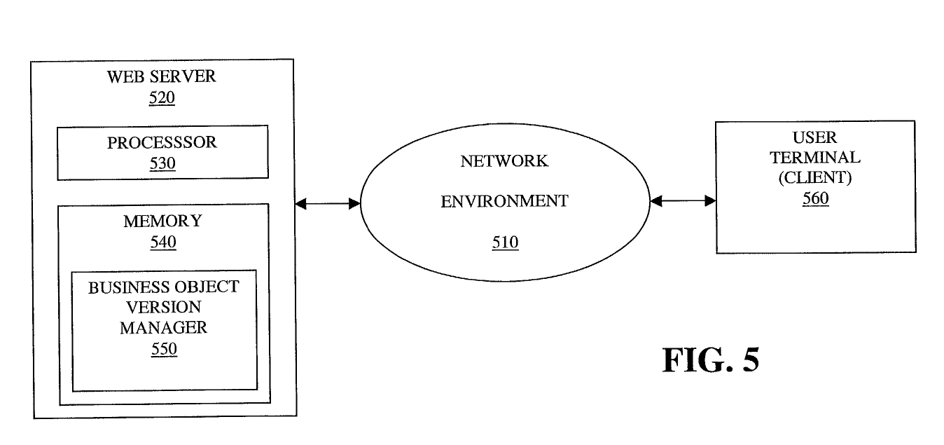

FIG. 5 illustrates an exemplary network environment 510 in which the present invention can operate. As shown in FIG. 5, a web server 520 communicates over a network 510 with a user terminal 560. For example, the user 560 may submit a response to an RFQ to the web server 520. The RFQ handling process that coordinates the flow of the RFQ by the web server 520 may be managed in accordance with a business object version manager 550 incorporating features of the present invention, as discussed above in conjunction with FIG. 3. The network 510 can be any wired or wireless network for transferring information, such as a data network or a telephone network.

Memory 540 will configure the processor 530 to implement the methods, steps, and functions disclosed herein. The memory 540 could be distributed or local and the processor 530 could be distributed or singular. The memory 540 could be implemented as an electrical, magnetic or optical memory, or any combination of these or other types of storage devices. The term “memory” should be construed broadly enough to encompass any information able to be read from or written to an address in the addressable space accessed by processor 530. With this definition, information on a network 510 is still within memory 540 of the web server 520 because the processor 530 can retrieve the information from the network 510.

As is known in the art, the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk.

It is to be understood that the embodiments and variations shown and described herein are merely illustrative of the principles of this invention and that various modifications may be implemented by those skilled in the art without departing from the scope and spirit of the invention.

What is claimed is:

1. A method for modifying a business object managed by a state machine, said method comprising the steps of:
maintaining said business object in an active state during said modification;
creating a new version of said business object, said new business object version having one or more attributes of said original business object and one or more modifications to said original attributes;
maintaining said new business object version in an inactive state during said modification; and
transferring said new business object version to an active state and said original business object to an inactive state when said modification is complete.

2. The method of claim 1, wherein said business object is a contract.

3. The method of claim 1, wherein said business object is an offer for sale.

4. The method of claim 1, wherein said business object is a request for quotes.

5. The method of claim 1, wherein said business object is associated with a trading mechanism.

6. The method of claim 1, further comprising the step of evaluating an authority of an initiator of said modification.

7. The method of claim 1, further comprising the step of including a reference to said original business object in said new business object.

8. The method of claim 1, wherein said transferring step is conditioned upon appropriate approvals for said modification.

9. The method of claim 1, further comprising the step of updating a child object that is dependent on said business object.

10. The method of claim 9, wherein said step updating said dependent object is performed in accordance with a business process associated with said dependent object.

11. The method of claim 9, wherein said step of updating said dependent object further comprises the step of updating references in responses to said business object to refer to said new business object version.

12. The method of claim 9, wherein said step of updating said dependent object further comprises the step of sending a notification of said modification to a submitter of a response to said business object.

13. A method for modifying a business object managed by a state machine, said method comprising the steps of:
maintaining said business object in an active state during said modification;
modifying said business object to create a new version of said business object; and
activating said new business object version when said modification is complete.

14. The method of claim 13, further comprising the step of evaluating an authority of an initiator of said modification.

15. The method of claim 13, further comprising the step of including a reference to said original business object in said new business object.

16. The method of claim 13, wherein said activating step is conditioned upon appropriate approvals for said modification.

17. The method of claim 13, further comprising the step of updating a child object that is dependent on said business object.

18. A system for modifying a business object managed by a state machine, comprising:
a memory that stores computer-readable code; and
a processor operatively coupled to said memory, said processor configured to implement said computer-readable code, said computer-readable code configured to:
maintain said business object in an active state during said modification;
create a new version of said business object, said new business object version having one or more attributes of said original business object and one or more modifications to said original attributes;
maintain said new business object version in an inactive state during said modification; and
transfer said new business object version to an active state and said original business object to an inactive state when said modification is complete.

19. A system for modifying a business object managed by a state machine, comprising:
a memory that stores computer-readable code; and
a processor operatively coupled to said memory, said processor configured to implement said computer-readable code, said computer-readable code configured to:
maintain said business object in an active state during said modification;
modify said business object to create a new version of said business object; and
activate said new business object version when said modification is complete.

20. An article of manufacture for modifying a business object managed by a state machine, comprising:
a computer readable medium having computer readable code means embodied thereon, said computer readable program code means comprising:
a step to maintain said business object in an active state during said modification;
a step to create a new version of said business object, said new business object version having one or more attributes of said original business object and one or more modifications to said original attributes;
a step to maintain said new business object version in an inactive state during said modification; and
a step to transfer said new business object version to an active state and said original business object to an inactive state when said modification is complete.

21. An article of manufacture for modifying a business object managed by a state machine, comprising:
a computer readable medium having computer readable code means embodied thereon, said computer readable program code means comprising:
a step to maintain said business object in an active state during said modification;
a step to modify said business object to create a new version of said business object; and
a step to activate said new business object version when said modification is complete.
